(19) United States
(12) Patent Application Publication
(10) Pub. No.: US 2009/0044659 A1
(43) Pub. Date: Feb. 19, 2009

(54) ASYMMETRICAL FLEXPLATE

(75) Inventors: Noe Brambila, Berwyn, IL (US); Anilkumar Vankayala, Chicago, IL (US)

Correspondence Address: INTERNATIONAL ENGINE INTELLECTUAL PROPERTY COMPANY, 4201 WINFIELD ROAD, P.O. BOX 1488, WARRENVILLE, IL, 60555, US

(73) Assignee: International Engine Intellectual Property Company, LLC, Warrenville, IL (US)

(21) Appl. No.: 11/837,765

(22) Filed: Aug. 13, 2007

(51) Int. Cl. F16F 15/30

(52) U.S. Cl. 74/572.2; 464/98

(57) ABSTRACT

A flexplate (10) that is configured for attachment to an engine crankshaft and a transmission, includes a generally circular plate (12) having a mounting portion (20) disposed generally centrally on the plate (12). An outer rim portion (16) is disposed peripherally around the plate (12), and a transition portion (18) is disposed between the mounting portion (20) and the outer rim portion (16). At least one counterweight (50) is disposed on the transition portion (18) of the plate (12). The flexplate (12) has only one axis of symmetry (B-B) that lies along a plane defined by the plate (12).

### FIELD OF THE INVENTION

The present invention relates generally to a flexplate used with an internal combustion engine. More specifically, the present invention relates to a flexplate joined to the end surface of a crankshaft of an internal combustion engine.

### BACKGROUND OF THE INVENTION

A conventional flexplate or flywheel is a heavy rotating disk that is bolted onto the crankshaft at the rear of an engine. The flexplate rotates with the end of the engine crankshaft. A rotational momentum of the flexplate resists fluctuations in torque and rotational speed of the crankshaft due to combustion events in the engine. The resistance imparted by the flexplate helps steady the rotation of the engine crankshaft when an uneven torque is exerted on the flexplate by the engine. In this configuration, the flexplate absorbs and reduces the amount of rattling and vibration from the engine.

The crankshaft of an engine has a certain amount of imbalance during operation that mostly depends on the arrangement of the engine cylinders and the rotational speed of the engine. The imbalance causes the crankshaft to twist and bend. To address the imbalance, counterweights are conventionally placed on a rim surface of the flexplate, or alternatively placed between the flexplate and the rear of the engine, to reduce the amount of imbalance. The location and configuration of the counterweights on the flexplate is limited by the clearance between the flexplate and the rear of the engine. In some cases, there is insufficient space for the counterweights due to interferences with engine components, particularly with bolts in the rear housing of the engine.

### BRIEF SUMMARY OF THE INVENTION

A flexplate that is configured for attachment to an engine crankshaft and a transmission, includes a generally circular plate having a mounting portion disposed generally centrally on the plate. An outer rim portion is disposed peripherally around the plate, and a transition portion is disposed between the mounting portion and the outer rim portion. At least one counterweight is disposed on the transition portion of the plate. The flexplate has only one axis of symmetry that lies along a plane defined by the plate.

### BRIEF DESCRIPTION OF THE DRAWINGS

FIG. 1 is a plan view of a first side of an asymmetric flexplate in accordance with the invention.

FIG. 2 is a cross-sectional view of the asymmetric flexplate taken along line A-A of FIG. 1, in accordance with the invention.

FIG. 3 is a plan view of a second side of the asymmetric flexplate in accordance with the invention.

### DETAILED DESCRIPTION OF A PREFERRED EMBODIMENT

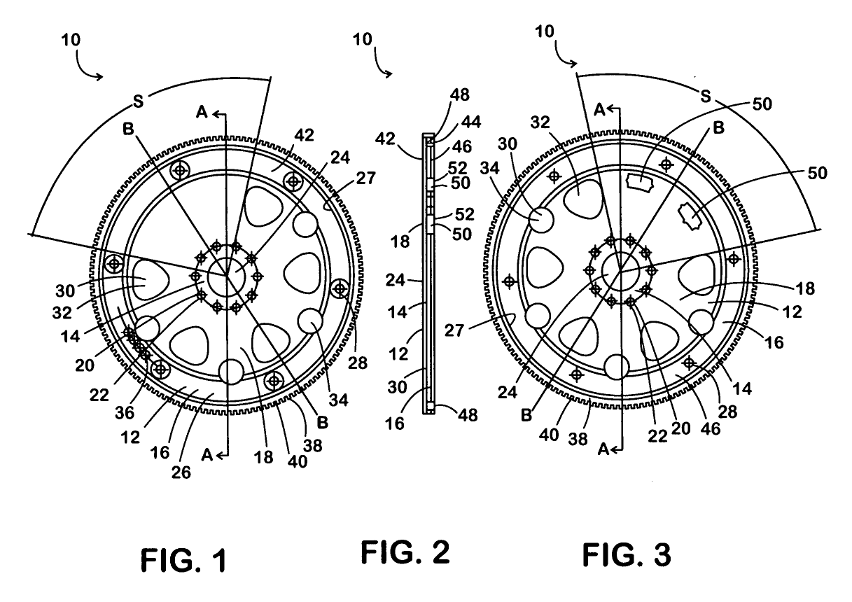

Various views of a flexplate 10 are shown in FIG. 1 through FIG. 3. The flexplate 10 is a relatively heavy rotating disk that includes a plate 12. The plate 12 is configured to be mounted onto an end of a crankshaft of an internal combustion engine (not shown), and is typically located on a side of the engine that connects to a transmission. The plate 12 is generally circular and has three portions, a crank mounting portion 14, an outer rim 16, and a transition portion 18 that is located between the crank mounting portion 14 and the outer rim portion 16.

The crank mounting portion 14 receives the engine crankshaft at a mounting structure 20. The mounting structure 20 has a plurality of bolt openings 22 formed therein that are advantageously arranged annularly and spaced apart from each other around a central hole 24. Bolts (not shown) are inserted one each through each of the bolt openings 22 and into the engine crankshaft. In the embodiment shown there are ten fitting holes 22 that are disposed annularly around the central hole 24 at about 36-degree increments, but other configurations may be used.

The flexplate 10 typically will interface with a transmission (not shown) that is connected to the engine when the engine is installed into a vehicle. The outer rim portion 16 is preferably slightly thicker than the transition portion 18, and forms a mounting surface 26 for the transmission. The central hole 24 of the crank mounting portion 14 provides a clearance for the “nose” of the transmission (not shown), as is known.

The outer rim portion 16 is located along a peripheral surface 27 of the plate 12. The outer rim portion 16 includes a plurality of mounting holes 28 are configured to receive a plurality of mounting bolts (not shown) that attach the flexplate 10 to the transmission. In this embodiment, six mounting holes 28 are shown concentrically disposed around the central hole 24 at about 60-degree increments, but other configurations may be used.

The transition portion 18 includes a plurality of removed portions 30, which are portions thereof that have been punched out from the plate 12 to reduce the stiffness of the plate 12, and to reduce the weight of the flexplate 10 in general. Even though the removed portions 30 are shown to extend through the plate 12, it is contemplated that the removed portions 30 may alternatively be indentations in the material of the plate 12 instead of punched out portions. The plate 12 of the flexplate 10 is advantageously made of steel, but other materials may be used.

In this embodiment, the removed portions 30 form a concentric pattern of alternating triangular-shaped portions 32 and circular-shaped portions 34 disposed around the central hole 24. The triangular-shaped portions 32 are larger and closer to the central hole 24 than the circular-shaped portions, each triangular-shaped portion being spaced at substantially the same radial distance from the central hole, and each circular-shaped portion being spaced at substantially the same radial distance from the central hole. While the size, shape and configuration of the removed portions 30 that are shown in FIGS. 1 and 3 effectively reduce the stiffness of the flexplate 10, it is contemplated that other sizes, shapes and configurations of removed portions can be used to obtain the desired amount of stiffness of the flexplate 10, while avoiding excessive localized areas of stress over the plate 12.

A plurality of balancing indentations or holes 36 are preferably located on the outer rim portion 16, radially outwardly of the removed portions 30 and at about the same radial distance from the central hole 24 as the mounting holes 28. While the drawing indicates that there are four balancing indentations 36 disposed on the plate 12 between two adjacent mounting holes 28, it is contemplated that the balancing indentations can be located at other locations on the outer rim portion 16 or elsewhere on the flexplate 10.

Around the peripheral surface 27 of the plate 12 is a starter ring-gear 38, which is typically a steel ring with teeth 40 that is fitted on the outer rim portion 16. The teeth 40 of the starter ring-gear 38 are driven by a pinion (not shown) of a starter motor (not shown) to transfer torque from the pinion to the flexplate 10 and rotate the engine to begin operation. The starter ring-gear 38 is attached to the plate 12, preferably with a weld, although other attachment structures are contemplated.

In this embodiment, the starter ring-gear 38 is flush with a first side 42 of the plate 12, and the starter ring gear forms a lip 44 on a second side 46 of the plate 12 and around the periphery of the plate 12. In this configuration, the plate 12 is recessed from a top surface 48 of the starter ring gear 38.

At least one or more counterweight(s) 50 is located on the transition portion 18. Two counterweights 50 are used in this embodiment. The counterweights 50 can be attached to or integrally formed with the plate 12. The counterweights 50 are located close the outer rim portion 16 of the flexplate 10 to have a larger effect on the rotational inertia than on the weight of the flexplate 10.

In this embodiment, the two counterweights 50 are spaced about 40-degrees from each other, measured center to center, and are each located at about the same radial distance from the central portion 24. Each of the counterweights 50 is disposed in the same sector “S” of the flexplate 10. The sector “S” is between 0 and 180-degrees, preferably about 90-degrees, however other ranges are contemplated.

The sector “S” containing the counterweights 50 advantageously has no removed portions 30. Typically, the pattern of the removed portions would extend concentrically and symmetrically 360-degrees around the central hole 24. It is believed by those skilled in the art that the removed portions 30 should be symmetrically disposed on the transition portion 18 of the flexplate 10. In a symmetrical configuration, the loading from the transmission onto the outer rim portion 16 is transferred evenly onto the transition portion 18, resulting in an even, symmetrical loading across the flexplate 10. It is considered questionable design practice in the art to have an asymmetrical configuration of removed portions 30 because it could cause the flexplate 10 to fatigue unevenly, and eventually fail at the localized area of weakness.

In the present flexplate 10, however, the pattern of removed portions 30 is eliminated from the sector “S” having the counterweights 50, resulting in an asymmetrical flexplate 10 configuration. In the asymmetrical flexplate 10, there is only a single axis of symmetry B-B that generally lies on the plane of the plate 12. Through testing, it has been found that the fatigue limit of the asymmetrical flexplate 10 is comparable with the prior art symmetrical flexplate.

When the counterweights 50 are not evenly distributed radially about the central hole 24, and further, when the removed portions 30 are not evenly distributed radially about the central hole 24, the asymmetrical configuration results in an imbalance of mass distribution across the flexplate 10. Specifically, the flexplate 10 is heavier over the sector “S” containing the counterweights 50 than in the remaining portion of the flexplate. The mass imbalance of the flexplate 10 is used to counter the imbalance of the engine crankshaft that causes the crankshaft to twist and bend, and can advantageously reduce the amount of counterweight designed into the crankshaft. Additionally, the balancing holes 36 may be positioned on the outer rim to counteract the counterweights 50, if necessary.

Since a flexplate 10 is more effective to counter the twisting of the engine crankshaft when the flexplate's inertia is larger, it is preferable that the counterweights 50 are disposed closer to the outer rim portion 16 of the transition portion 18 than to the crank mounting portion 14. In this configuration, more mass is located farther from the center of rotation, which results in larger inertia.

The counterweights 50 sit within the recess formed by the plate 12 and the starter ring gear 38. The counterweights 50 preferably have a height that is generally the same height as the starter ring gear 38 so that a top surface 52 of the counterweights 50 is generally flush with the top surface 48 of the starter ring gear 38. It is contemplated that the height of the top surface 52 of the counterweight 50 can be different from the top surface 48 of the starter ring gear 38, and further, that the heights of each counterweight can differ.

With the counterweights 50 disposed in the recess, the top surface 52 preferably does not protrude, or only protrudes to a small extent, from the top surface 52 of the starter ring gear 38. In this configuration, the counterweights 50 take up little to none of the clearance space between the flexplate 10 and the rear of the engine.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A flexplate configured for attachment to an engine crankshaft and a transmission, comprising:
a generally circular plate having a mounting portion disposed generally centrally on the plate;
an outer rim portion disposed peripherally around the plate;
a transition portion disposed between the mounting portion and the outer rim portion; and
at least one counterweight disposed on the transition portion of the plate;
wherein the flexplate has only one axis of symmetry that lies along a plane defined by the plate.

2. The flexplate of claim 1 wherein the at least one counterweight comprises a plurality of counterweights.

3. The flexplate of claim 2 wherein the plurality of counterweights is disposed in a sector of the flexplate, and wherein the sector is between 0 and 180-degrees.

4. The flexplate of claim of claim 2 wherein the plurality of counterweights is disposed in a sector of the flexplate, wherein the sector is about 90-degrees.

5. The flexplate of claim 1 further comprising a gear ring attached to a peripheral surface of the plate, wherein the gear ring defines a lip around the plate.

6. The flexplate of claim 5 wherein the lip has a top surface, wherein the counterweight has an additional top surface, and wherein the top surface and the additional top surface have substantially the same height with respect to the plane of the plate.

7. The flexplate of claim 5 wherein the at least one counterweight is disposed on the transition portion closer to the outer rim portion than to the mounting portion.

8. A flexplate configured for attachment to an engine crankshaft and a transmission, comprising:
a generally circular plate having a crankshaft mounting portion disposed generally centrally on the plate, an outer rim portion disposed at the periphery of the plate, and a transition portion located between the crankshaft mounting portion and the outer rim portion;
wherein the transition portion has a single axis of symmetry laying in the plane of the plate.

9. The flexplate of claim 8 further comprising at least one counterweight disposed on the transition portion.

10. The flexplate of claim 9 wherein the at least one counterweight comprises a plurality of counterweights.

11. The flexplate of claim 10 wherein the plurality of counterweights is disposed in a sector of the flexplate, wherein the sector is between 0 and 180-degrees.

12. The flexplate of claim of claim 10 wherein the plurality of counterweights are disposed in a sector of the flexplate, wherein the sector is about 90-degrees.

13. The flexplate of claim 9 further comprising a gear ring attached to a peripheral surface of the plate, the gear ring defining a lip around the plate.

14. The flexplate of claim 13 wherein the lip has a top surface, wherein the at least one counterweight has a top surface, and wherein the top surface of the lip and the top surface of the at least one counterweight have substantially the same height.

15. A flexplate configured for attachment to an engine crankshaft and a transmission, comprising:
a generally circular plate having a central hole and a peripheral surface; and
a plurality of removed portions located on the plate portion between the central hole and the peripheral surface, wherein the removed portions are disposed in a generally concentric pattern around a portion of the central hole, and wherein there are no removed portions in a sector surrounding a remaining portion of the central hole.

16. The flexplate of claim 15, further comprising at least one counterweight disposed on the sector.

17. The flexplate of claim 16, wherein the at least one counterweight comprises a plurality of counterweights disposed at the same radial distance from the central hole.

18. The flexplate of claim 15, wherein the plate has a crankshaft mounting portion disposed generally centrally on the plate, an outer rim portion disposed at the periphery of the plate, and a transition portion disposed between the crankshaft mounting portion and the outer rim portion.

19. The flexplate of claim 15, wherein the sector is between 0 and 180 degrees.

20. The flexplate of claim 19, wherein the sector is about 90-degrees.
